(19) United States
(12) Patent Application Publication
(10) Pub. No.: US 2003/0116144 A1
(43) Pub. Date: Jun. 26, 2003

(54) Independently variable boost supercharging

(76) Inventor: Alexis Ivan Portalatin, Tampa, FL (US)

Correspondence Address: Mr. Alexis I. Portalatin, 11401 Wheeling Dr., Tampa, FL, 33625, US

(21) Appl. No.: 10/025,715

(22) Filed: Dec. 26, 2001

(51) Int. Cl. F02B 33/00

(52) U.S. Cl. 123/564

(57) ABSTRACT

This invention pertains to a method of providing independently variable boost supercharging to an internal combustion engine by means of the adaptation of an electric axial flow ducted fan.

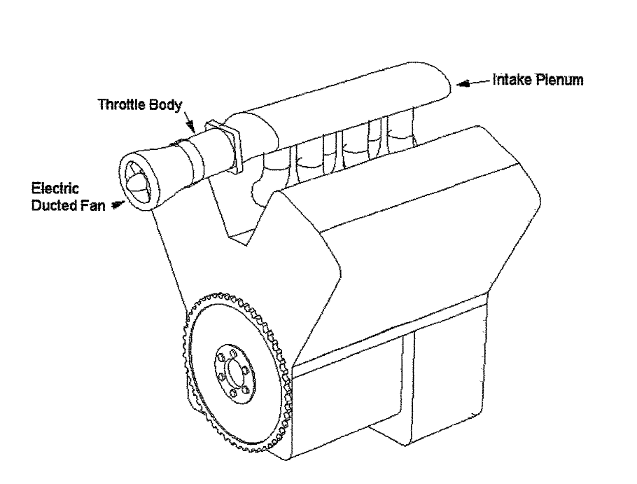

### BACKGROUND OF THE INVENTION

Supercharging has been a traditional method of increasing the efficiency and power output of positive displacement internal combustion engines.

Supercharging is generally done in one of two ways, either by directly driving a compressor from the engines output shaft, or by connecting the compressor to a turbine that is powered by engine exhaust gasses, a method called turbocharging. Either method involves additional weight, complexity and cost. There has heretofore existed no relatively simple, inexpensive and lightweight method of achieving this goal.

### BRIEF SUMMARY OF THE INVENTION

The present invention describes a method of providing variable boost to an internal combustion engine using an electric ducted fan device similar to those used to power flying model aircraft. The ducted fan is connected to the intake manifold to provide the mass flow necessary to increase the absolute pressure in the intake plenum, and thus the efficiency and power output at a given rotational speed. Control of the electric ducted fan is by means of programmed electronic control.

This method addresses the shortcomings mentioned in the previous section in that it is considerably less expensive, lighter, and less complex than the prior art.

### BRIEF DESCRIPTION OF THE DRAWINGS

The presented FIGURE is an isometric view with perspective of a six-cylinder engine with an electric ducted fan fitted to the intake manifold.

### DETAILED DESCRIPTION OF THE INVENTION

A variable mass flow device feeds air into the intake plenum of a positive displacement (piston or Wankel) type internal combustion engine. The internal combustion engine can be spark ignition, glow ignition, or diesel. The air is fed at a high enough volume rates so that the pressure in the intake plenum, or manifold, is maintained at a level higher than it would have if it were feeding directly from the atmosphere. Thus, a supercharging effect is obtained that raises the efficiency and torque output of the internal combustion engine at its operating rotational speed.

The variable mass flow device is electrically driven and is an adaptation of an axial flow ducted fan such as those used to power flying model aircraft.

The internal combustion engine is protected from over-boosting by an electronic control that limits ducted fan performance as a function of computed brake mean effective pressure (BMEP).

The electric ducted fan is sized so that it can produce a mass flow greater than the requirements of the internal combustion engine at the design rotational speed. When the ducted fan is producing a mass flow greater than that required by the internal combustion engine, backpressure will be generated. This backpressure is further increased by blockage due to partial opening of the throttle body valve, and may become large enough to cause blade stall in the axial flow fan. Thus the amount of supercharging available may be limited and proportional to the ratio between manifold pressure and inlet pressure and to the ratio of fan blade tip speed to the sum of free stream air speed and induced flow velocity at the inlet.

If the electric ducted fan is designed to have its blades filly loaded in the maximum static thrust case, it may not be possible to operate it as a supercharger while at zero forward speed. In this case, a finite value of forward speed will be required before the unit is put in operation.

In order to further alleviate backpressure, the ducted fan is only allowed to operate when the valve in the throttle body is fully open.

The power absorbed by the electric ducted fan may be greater than the power generated by the charging device attached to an internal combustion engine, which is typically an alternator sized to replenish the energy used by the starter, lighting, and accessories in an automobile or aircraft. Thus, it may not be possible to operate the electric ducted fan as a full time supercharger at its maximum power output. In this case, the electric ducted fan can be used as a temporary, or transient boost device, to provide supercharging when additional power is needed, such as take off and climb in an aircraft, or a quick burst of power for passing in an automobile.

When used at less than maximum output, at a level sustainable by the internal combustion engine's electrical system, the electric ducted fan can be used to maintain near sea level pressure at the engine's intake, thus allowing an aircraft powered by a piston engine to reach higher altitudes

The exhaust nozzle of the electric ducted fan is faired in to the inlet of the throttle body of the internal combustion engine. Such fairing is done in a manner that minimizes any flow efficiency loss in the duct or diffuser leading to the throttle body.

Ducted Fan Control

The electric ducted fan is controlled by a solid-state device such as those used to control flying model aircraft or racing model cars. Control of the electric ducted fan can be manual, automatic, or automatic with a manual override feature. The three modes are described as follows:

Mode 1: Manual

In manual mode, an independent module directly controls the operation of the electric ducted fan, using a solid-state controller like those used to control similar electric ducted fans in flying model aircraft.

Mode 2. Automatic

In automatic control mode, an electronic control module is programmed to generate a control signal that is proportional to the difference between outside static air pressure and standard sea level pressure.

Mode 3. Automatic with a Manual Override

In the automatic with a manual override mode, the control signal is generated to be the larger of the manual and automatic signal.

Over-Boost Protection

The control signal generated in any of the control modes is limited to a value that is proportional to the ratio of engine rotational speed (RPM) to the gas pressure inside the intake manifold. The resulting signal is then used to control the ducted fan. This results in a stable closed loop which protects the engine from over-boosting, while allowing control of available boost

Blade Stall Protection

The resulting controlling signal can be further limited to a value that is proportional to a mapped ratio of drawn current to fan speed, thus preventing inefficient operation due to blade stall.

### EXAMPLE

An electric ducted fan is sized to provide variable boost to a 3.5 liter six cylinder engine that normally produces maximum power at around 5300 RPM. The no-loss volume flow required by the engine at maximum power is:

Volume Flow (engine)=Engine Displacement×RPM/2=9,275 liters per minute

A typical commercially available Electric Ducted Fan unit has an efflux speed of 41 meters/sec through an affective efflux area of 49 cm square while consuming 407 watts at 12 volts.

The volume flow generated by the Electric Ducted Fan unit is

Volume Flow (ducted fan)=60×100×Efflux Speed×Efflux Area/1000=12,054 liters per minute

The pressure rise due to the difference in volume flows at nearly the same temperature is

Pressure Ratio=Volume Flow (fan)/Volume Flow (engine)=12,054/9275=1.2996

This pressure rise will increase the effective angle of attack at the axial fan blade. This increase in nullified by increasing dynamic inlet pressure resulting from forward movement through the air. The design is workable at the maximum power operating point when the unit is exposed to airflow above a speed where the computed blade angle of attack is then less than that required for blade stall. This minimum forward airspeed can be determined empirically.

What I claim as my invention is:

I A method for providing variable boost supercharging for a positive displacement internal combustion engine using an axial electric ducted fan.

II A method of maintaining near sea level pressure at the inlet of a piston aircraft engine at altitudes higher than sea level by means of an electric ducted fan.

III A method of controlling the operation of an electric ducted fan when used as a supercharger to avoid over-boosting the internal combustion engine or stalling of the ducted fan blades.
